(19) United States
(12) Patent Application Publication
(10) Pub. No.: US 2009/0073525 A1
(43) Pub. Date: Mar. 19, 2009

(54) DISPLAY DEVICE

(75) Inventor: Akihiko TATEIWA, Nagano-shi (JP)

Correspondence Address: DRINKER BIDDLE & REATH (DC), 1500 K STREET, N.W., SUITE 1100, WASHINGTON, DC, 20005-1209, US

(73) Assignee: SHINKO ELECTRIC INDUSTRIES CO., LTD., Nagano-shi (JP)

(21) Appl. No.: 12/118,200

(22) Filed: May 9, 2008

(30) Foreign Application Priority Data
May 11, 2007 (JP) 2007-126487

(51) Int. Cl. G02B 26/10

(52) U.S. Cl. 359/201.1; 359/209.1; 359/210.1

(57) ABSTRACT

A display device includes a laser light source, refraction means for refracting a laser beam emitted from the laser light source, and scan means for scanning the refracted laser beam by driving the refraction means. Further, in the display device, the scan means includes first scan means and second scan means that change a position of the refraction means with respect to the laser light source along two directions orthogonal to each other. Further, the refraction means includes first refraction means driven by the first scan means and second refraction means driven by the second scan means.

This application is based on and claims priority from Japanese Patent Application No. 2007-126487, filed on May 11, 2007, the entire contents of which are hereby incorporated by reference.

### BACKGROUND OF THE INVENTION

1. Technical Field

The present disclosure relates to a display device that performs displaying operation by scanning a laser beam emitted from a laser light source.

2. Background Art

In a display device for displaying an image, a liquid-crystal display (LCD) or a plasma display panel (PDP) are much used in recent years in place of a conventional cathode-tube (CRT). However, since there is a limit on miniaturization of the LCD and the PDP, attention is paid to a projector-type display device as a mobile-compatible display device because it is easy to miniaturize the projector-type display device to a portable size. The projector is a display device for projecting a certain image on a screen in an enlarged manner. The projector main body has a structure that does not include a screen, and thus has an advantage that miniaturization and weight reduction can be performed easily.

As shown in FIG. 1, the projector-type display device has a structure in which a laser beam emitted from a light source 1 is scanned using polygon mirrors 2 and 3 assigned to a direction X and a direction Y, respectively, thereby projecting an image on a screen 6. A galvano mirror may be used instead of the polygon mirror (see e.g., JP-A-2-221995).

However, when a polygon mirror or a galvano mirror is used, two mirrors must be accurately positioned along two scan directions (a direction X and a direction Y) orthogonal to each other. Thus, there is a problem in that manufacturing cost increases resultant from complication of a structure of the display device. Further, since two driving mirrors must be provided, there is a problem in that miniaturization of the projector is difficult.

### SUMMARY OF THE INVENTION

Exemplary embodiments of the present invention provide a display device that has a simple structure and that is easy to miniaturize.

According to one or more aspects of the present invention, a display device includes: a laser light source; refraction means for refracting a laser beam emitted from the laser light source; and scan means for scanning the refracted laser beam by driving the refraction means.

According to one or more aspects of the present invention, a display device includes: a laser light source; an optical lens for refracting a laser beam emitted from the laser light source; a first piezoelectric element coupled to the optical lens and for changing a first position of the optical lens in a first direction orthogonal to an optical axis of the laser beam; a second piezoelectric element coupled to the optical lens and for changing a second position of the optical lens in a second direction orthogonal to the optical axis and the first direction; and a screen on which the refracted laser beam is projected, wherein the refracted laser beam is scanned on the screen by driving the first and second piezoelectric elements.

According to one or more aspects of the present invention, a display device includes: a laser light source; an optical lens for refracting a laser beam emitted from the laser light source; a first torsion bar for changing a first rotation angle with respect to a first rotational axis of the optical lens, said first rotational axis being orthogonal to an optical axis of the laser beam; a second torsion bar for changing a second rotation angle with respect to a second rotational axis of the optical lens, said second rotational axis being orthogonal to the optical axis and the first rotational axis; a screen on which the refracted laser beam is projected, wherein the refracted laser beam is scanned on the screen by driving the first and second torsion bars.

According to one or more aspects of the present invention, in a method of scanning a laser beam, the method includes: a) applying the laser beam to refraction means for refracting the laser beam; b) driving the refraction means; and c) projecting the refracted laser beam on a screen.

According to the present invention, a display device that has a simple structure and that is easy to miniaturize can be provided.

Other aspects and advantages of the invention will be apparent from the following description, the drawings and the claims.

### BRIEF DESCRIPTION OF THE DRAWINGS

FIG. 1 is a view showing an example of the related-art display device;

FIG. 2A is a view (#1) showing operation of a display device according to the present invention;

FIG. 2B is a view (#2) showing operation of the display device according to the present invention;

FIG. 2C is a view (#3) showing operation of the display device according to the present invention;

FIG. 3 is a view showing a modification of the display device according to the present invention;

FIG. 4 is a view showing another modification of the display device according to the present invention;

FIG. 5A is a view (#1) showing another operation of the display device according to the present invention;

FIG. 5B is a view (#2) showing another operation of the display device according to the present invention;

FIG. 6 is a schematic view showing scan means of the display device;

FIG. 7 is a view showing a display device of a first embodiment;

FIG. 8 is a view showing a display device of a second embodiment;

FIG. 9 is a view showing a display device of a third embodiment; and

FIG. 10 is a view showing refraction means used in the display device shown in FIG. 9.

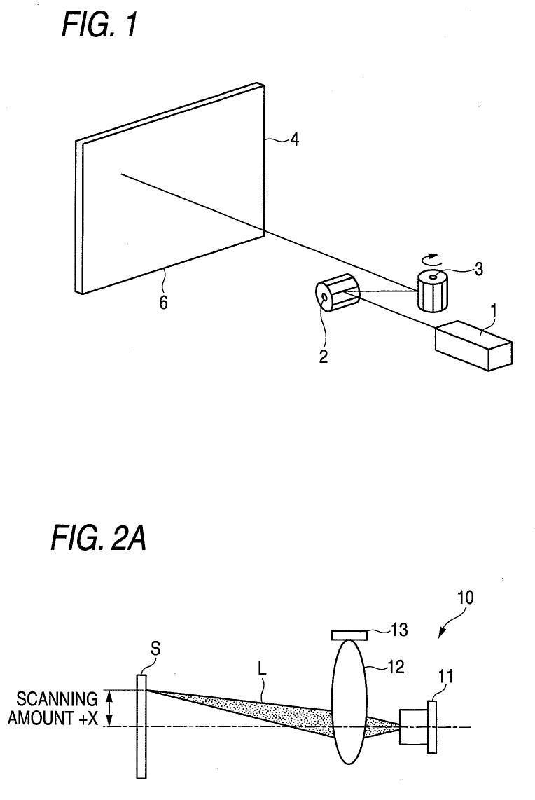

### DETAILED DESCRIPTION

Exemplary embodiments of the present invention will be described hereunder with reference to the drawings.

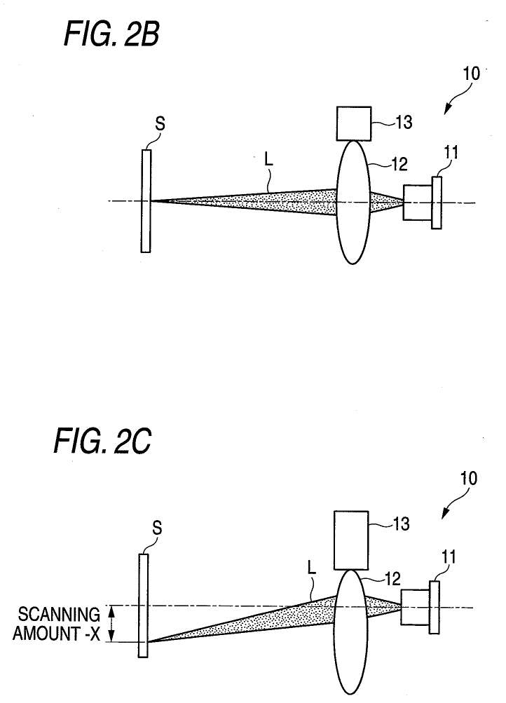

FIGS. 2A to 2C are schematic views showing an example of operation of a projector-type display device according to the present invention. By reference to FIGS. 2A to 2C, a display device 10 shown in the drawings includes a laser light source 11 such as a laser diode for emitting a laser beam, and refraction means 12 such as an optical lens for forming an image on a screen S by refracting a laser beam L emitted from the laser light source 11.

The display device 10 is characterized in that the refraction means 12 is driven by scan means 13, thereby scanning a laser beam (an image-formation beam) L arriving at a screen S.

For instance, the scan means 13 may be a piezoelectric element capable of controlling contraction and expansion by application of a voltage. The position of the refraction means 12 relative to the laser light source 11 is changed by controlling application of a voltage, thereby changing a position on a curved surface at which the laser beam L enters the refraction means (an optical lens) 12. Motions shown in FIGS. 2A to 2C are continually repeated by the above control operation, so that scanning of the laser beam L can be performed.

FIGS. 2A to 2C show a one-dimensional scanning for convenience of illustration. The scan means is provided in such a manner that the refraction means 12 moves also in a direction perpendicular to the direction along which the refraction means 12 is moved by the scan means 13, and then scanning of the laser beam L is performed in two directions orthogonal to each other (the horizontal direction and the vertical direction). Thus, scanning for displaying an image on the screen S can be performed.

For instance, scanning is performed such that the angle of the laser beam after passing the refraction means 12 is in a range of −45 degrees to +45 degrees with respect to an optical axis of the laser light source 11. Further, the angle of the normal line of the refraction means 12 (an optical lens) with respect to the optical axis of the laser light source 11, at a point where the laser beam enters, is in a range of −90 degrees to 90 degrees. A refractive index of the refraction means 12 may be set to 1.1 to 3.0.

In displaying 640×480 VGA image, as an example, a horizontal scanning needs to be set to 14.4 kHz or more and a vertical scanning needs to be set to 60 kHz or more on condition that scan speed per screen is one-sixtieths seconds.

The display device 10 is simpler in structure than a related-art display device that scans laser beam using a polygon mirror or a galvano mirror. Further, the display device 10 does not require fine adjustment of a mirror position. Therefore, cost incurred by assembling the display device can be reduced.

The display device 10 enables miniaturization and weight reduction because a movable mirror such as a galvano mirror or a polygon mirror is not required. Further, in using a galvano mirror or a polygon mirror, a collimation optical system for collimating a light beam emitted from a laser light source is required. Meanwhile, the display device 10 of the embodiment does not need the collimation optical system required in the related-art, and thus a more compact and simplified display device can be implemented.

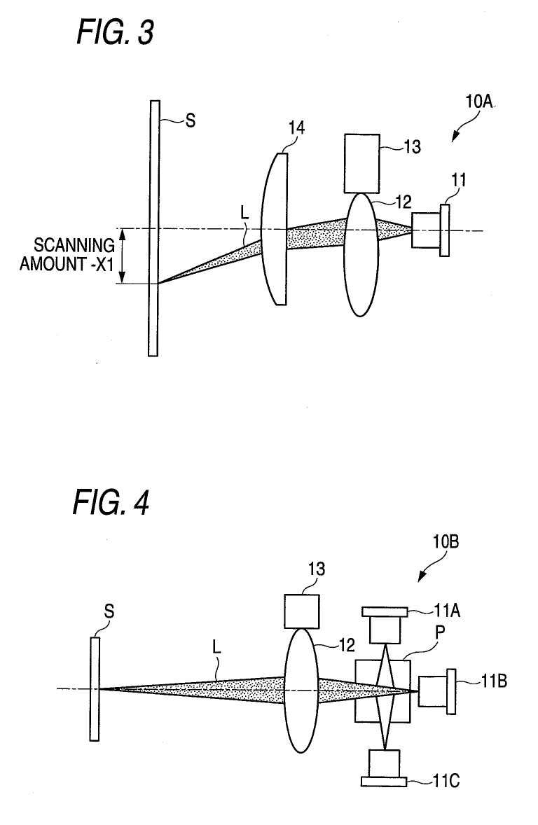

The display device 10 shown in FIGS. 2A to 2C may also be modified or altered as described below. FIGS. 3 and 4 are schematic views showing display devices 10A and 10B which are modifications of the display device 10. The above-described elements are assigned the same reference numerals, and their descriptions are omitted (the same also applies to drawings and embodiments described below).

By reference to FIG. 3, the display device 10A described in the drawings is characterized in that refraction means 14 for further refracting the laser beam L refracted by the refraction means 12 is interposed between the refraction means 12 and the screen S. The refraction means 14 is e.g., a wide-angle lens, and can extend an area over which the display device can perform scanning. Thus, a display screen projected on the screen S can be made larger. Accordingly, the refraction means (an optical lens) may also be configured such that a plurality of refraction means are combined in accordance with specification (e.g., the size of a screen).

By reference to FIG. 4, the display device 10B shown in the drawing is characterized by having three laser light sources (laser light sources 11A, 11B, and 11C). Laser beams emitted from the laser light sources 11A, 11B, and 11C are synthesized by synthesis means P such as a prism, and then the thus-synthesized beam enters the refraction means 12.

Therefore, the display device 10B can project a desired color of laser beam by combining various colors generated by laser light sources.

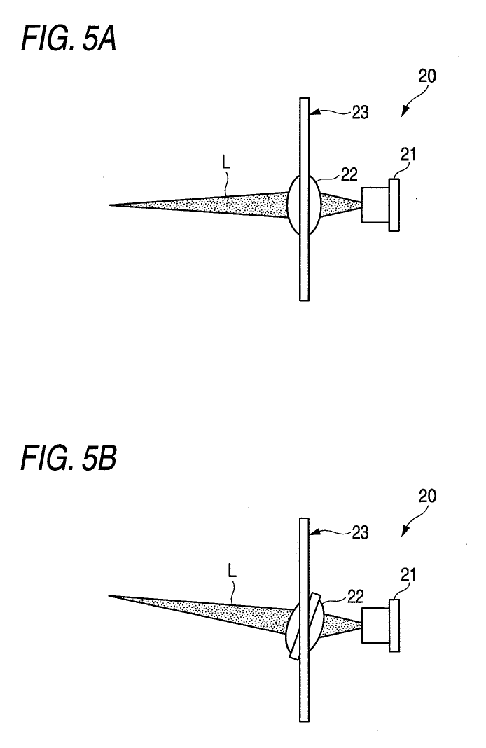

The scan means for scanning a laser beam is not limited to the embodiment shown in FIGS. 2A to 2C or that shown in FIGS. 3 and 4. For instance, as shown in FIGS. 5A and 5B, the scan means may also be configured such that refraction means is driven, to thus change an angle of a laser beam entering the refraction means.

FIGS. 5A and 5B are schematic views showing operation of the display device 20 that is another example of the display device according to the present invention.

By reference to FIGS. 5A and 5B, the display device 20 has a laser light source 21 corresponding to the above-described laser light source 11 and refraction means 22 corresponding to the refraction means 12. Like the display device 10, the display device is configured such that the scan means 23 scans the laser beam L. In the display device 20 shown in the drawings, the scan means 23 drives the refraction means 22 such that an angle of the laser beam L entering the refraction means 22 changes.

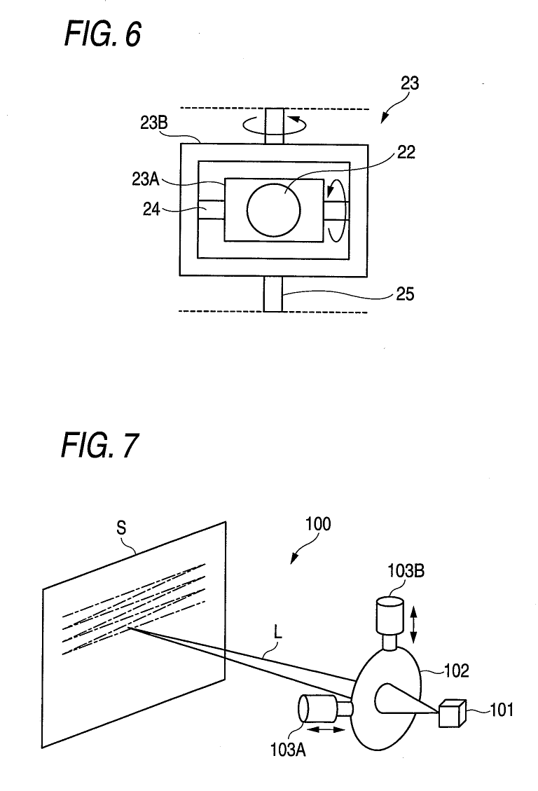

FIG. 6 is a plan view of the scan means 23 when viewed from the laser light source 21. By reference to FIG. 6, the scan means 23 is configured such that a first retaining section 23A for retaining the refraction means 22 is retained by a second retaining section 23B via a torsion bar 24 and such that the second retaining section 23B is further coupled to a torsion bar 25.

In the above configuration, a rotational angle of the first retaining section 23A is controlled by the torsion bar 24. A rotational angle of the second retaining section 23B is controlled by the torsion bar 25. Thus, a first rotational angle of the refraction means 22 with respect to the first rotational axis and a second rotational angle with respect to the second rotational axis perpendicular to the first rotational angle of the refraction means 22 are controlled. Therefore, like the above-described display device 10, a scanning of the laser beam L is performed in two directions (a horizontal direction and a vertical direction) orthogonal to each other, so that scanning for displaying an image on the screen S can be performed.

A further specific example of the display device will now be described below by reference to the drawings.

### FIRST EMBODIMENT

FIG. 7 is a perspective view schematically showing a display device 100 of a first embodiment of the present invention. By reference to FIG. 7, the display device 100 of the present embodiment has a laser light source 101 (e.g., a laser diode) for emitting a laser beam, and refraction means 102 (e.g., an optical lens) for refracting a laser beam L emitted from the laser light source 101, to thus form an image on the screen S.

The display device 100 is configured such that refraction means 102 is driven by scan means 103A and 103B, to thus scan a laser beam (an image-formation beam) L arriving at the screen S.

The laser light source 101 may be a red laser having a wavelength of 635 nm and output power of 10 mW. Further, the scan means 103A and 103B may be piezoelectric elements that can control contraction and expansion by application of a voltage. The piezoelectric elements 103A and 103B change the position of the refraction means 102 along two directions orthogonal to each other, whereby a position at which the laser beam L enters the refraction means (the optical lens) 102 is changed, to thus perform scanning of the laser beam L.

A piezoelectric element having a resonance frequency of 14 kHz, a stroke length of 50 μm, and an operating voltage of −30 V to +150 V may be used as the piezoelectric element 103A. Further, a piezoelectric element having a resonance frequency of 110 Hz, a stroke length of 150 μm, and an operating voltage of 0 V to +150 V may be used as the piezoelectric element 103B.

By using the display device 100, projection image of about 10 inches can be formed at a position 50 cm apart from the refraction means 102.

### SECOND EMBODIMENT

In the above display device 100, the two scan means 103A and 103B for driving the refraction means 102 are disposed for one refraction means 102 in directions perpendicular to each other. However, the scan means is not limited to such a configuration and can be variously configured as described below.

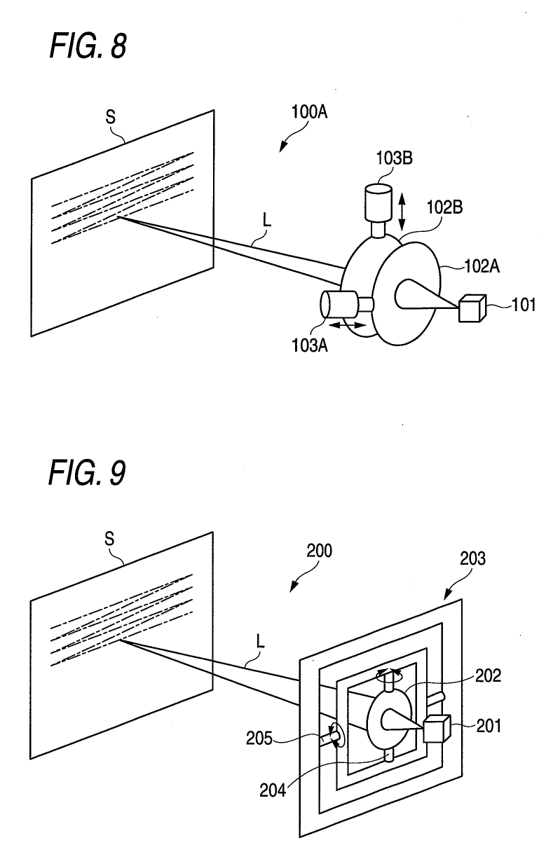

FIG. 8 is a perspective view schematically showing a display device 100A of a second embodiment of the present invention. Elements which are not specifically described are assumed to have the same structure as that of the elements of the first embodiment.

By reference to FIG. 8, the display device 10A of the present embodiment is characterized in that a plurality of refraction means for refracting the laser beam L emitted from the laser light source 101 are provided (refraction means 102A and 102B). Further, the refraction means 102A and 102B are provided with scan means 103A and 103B, respectively. The refraction means 102A is provided with the above-described scan means 103A, and the refraction means 102B is provided with the above-described scan means 103B. The refraction means 102A and 102B are configured to be moved along directions perpendicular to each other. In the present embodiment, the laser beam (an image-formation beam) L arriving at the screen S can be scanned as in the first embodiment.

As mentioned above, the refraction means and the scan means for driving the refraction means can be variously configured.

### THIRD EMBODIMENT

FIG. 9 is a perspective view schematically showing a display device 200 of a third embodiment of the present invention. By reference to FIG. 9, the display device 200 of the present embodiment has a laser light source 201 and refraction means 202 as in the case of the display devices 100 and 10A.

In the display device 200, the laser beam (image-formation beam) L arriving at the screen S is scanned such that the refraction means 202 is driven by the scan means 203 so as to change an angle of the laser beam L entering the refraction means 202.

In the scan means 203, a torsion bar 204 controls a first rotational angle of the refraction means 202 with respect to a first rotational axis, and a torsion bar 205 controls a second rotational angle of the refraction means 202 with respect to a second rotational axis orthogonal to the first rotational axis.

Consequently, like the above-described display devices 100 and 100A, the laser beam L is scanned in two directions (the horizontal direction and the vertical direction) orthogonal to each other, so that scanning for displaying an image on the screen S can be performed.

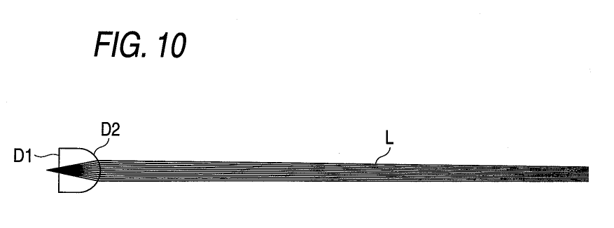

FIG. 10 is a schematic view of the refraction means (the optical lens) 202. A radius D1 of a surface of the refraction means 202 facing the laser light source 101 is set to 0.72 mm, and a curvature radius D2 of the surface of the refraction means opposite to the laser light source 201 is set to 1.25 mm.

Table 1 shows specifications of the torsion bars 204 and 205. In Table 1, “inside” corresponds to the torsion bar 204, and “outside” corresponds to the torsion bar 205.

TABLE 1

| | |
|---|---|
| Resonance frequency | Inside: 6400 Hz |
| | Outside: 320 Hz |
| Amplitude (Optical angle) | Inside: ±15° |
| | Outside: ±15° |
| | In DC-driven: ±3.5° |
| Drive Current (Sine wave) | Inside: 40 mAp-p |
| | Outside: 1.25 mAp-p, |
| | In DC-driven: 30 mA |

The display device 200 having the above configuration can form a projected image of about 10 inches at a position spaced 50 cm apart from the refraction means 202.

According to the present invention, the scan means (the piezoelectric element) used in the first or second embodiment may also be combined with the scan means (torsion bars) employed in the third embodiment. Further, another refraction means (a wide-angle lens) shown in FIG. 3 or the plurality of laser light sources and the synthesis means shown in FIG. 4 may also be combined with the configurations described in the first through third embodiments.

According to the present invention, the display device is also applicable to an apparatus using an optical deflector, such as a laser printer.

While the present invention has been shown and described with reference to certain exemplary embodiments thereof, it will be understood by those skilled in the art that various changes in form and details may be made therein without departing from the spirit and scope of the invention as defined by the appended claims. It is aimed, therefore, to cover in the appended claim all such changes and modifications as fall within the true spirit and scope of the present invention.

What is claimed is:

1. A display device comprising:
a laser light source;
refraction means for refracting a laser beam emitted from the laser light source; and
scan means for scanning the refracted laser beam by driving the refraction means.

2. The display device according to claim 1, wherein the scan means includes first scan means and second scan means that change a position of the refraction means with respect to the laser light source along two directions orthogonal to each other.

3. The display device according to claim 2, wherein the refraction means includes first refraction means driven by the first scan means and second refraction means driven by the second scan means.

4. The display device according to claim 1, wherein the scan means drives the refraction means such that an angle of the laser beam entering the refraction means is changed.

5. The display device according to claim 4, wherein
the scan means changes
a first rotation angle with respect to a first rotational axis of the refraction means, and
a second rotation angle with respect to a second rotational axis of the refraction means, second rotational axis being orthogonal to the first rotational axis.

6. The display device according to claim 1, wherein the refraction means is an optical lens.

7. The display device according to claim 1, further comprising:
another refraction means for further refracting the laser beam refracted by the refraction means.

8. The display device according to claim 1, further comprising:
a plurality of laser light sources; and
synthesis means for synthesizing laser beams emitted from the plurality of laser light sources, to thus cause the laser beams to enter the refraction means.

9. The display device according to claim 4, wherein
the scan means changes
a first position of the refraction means in a first direction, and
a second position of the refraction means in a second direction orthogonal to the first direction.

10. The display device according to claim 1, further comprising:
a screen on which the refracted laser beam is projected.

11. A display device comprising:
a laser light source;
an optical lens for refracting a laser beam emitted from the laser light source;
a first piezoelectric element coupled to the optical lens and for changing a first position of the optical lens in a first direction orthogonal to an optical axis of the laser beam;
a second piezoelectric element coupled to the optical lens and for changing a second position of the optical lens in a second direction orthogonal to the optical axis and the first direction; and
a screen on which the refracted laser beam is projected,
wherein the refracted laser beam is scanned on the screen by driving the first and second piezoelectric elements.

12. A display device comprising:
a laser light source;
an optical lens for refracting a laser beam emitted from the laser light source;
a first torsion bar for changing a first rotation angle with respect to a first rotational axis of the optical lens, said first rotational axis being orthogonal to an optical axis of the laser beam;
a second torsion bar for changing a second rotation angle with respect to a second rotational axis of the optical lens, said second rotational axis being orthogonal to the optical axis and the first rotational axis;
a screen on which the refracted laser beam is projected,
wherein the refracted laser beam is scanned on the screen by driving the first and second torsion bars.

13. A method of scanning a laser beam, the method comprising:
a) applying the laser beam to refraction means for refracting the laser beam;
b) driving the refraction means; and
c) projecting the refracted laser beam on a screen.

14. The method of claim 13,
wherein step (b) comprises:
changing a position of the refraction means in a direction orthogonal to an optical axis of the laser beam using a piezoelectric element.

15. The method of claim 13,
wherein step (b) comprises:
changing a rotation angle with respect to a rotation axis of the refraction means using a torsion bar.
